(19) United States
(12) Patent Application Publication
(10) Pub. No.: US 2009/0196581 A1
(43) Pub. Date: Aug. 6, 2009

(54) RECORDING/REPRODUCTION APPARATUS AND RECORDING/REPRODUCTION METHOD

(76) Inventor: Takayuki TSUTSUMI, Tachikawa-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/361,876

(22) Filed: Jan. 29, 2009

(30) Foreign Application Priority Data
Jan. 31, 2008 (JP) 2008-021902

(51) Int. Cl. H04N 5/917

(52) U.S. Cl. 386/124; 386/E05.007

(57) ABSTRACT

According to one embodiment, a recording/reproduction apparatus comprises a recording module configured to record input video data, an output module configured to output the input video data to a display apparatus, and a screen division module configured to reproduce, from the recording module, recorded video data related to present video data being outputted to the display apparatus, when a screen division instruction is supplied to the display apparatus while the input video data is being output to the display apparatus, and configured to output synthesized-screen data composed of the video data thus reproduced and the input video data.

### CROSS-REFERENCE TO RELATED APPLICATIONS

This application is based upon and claims the benefit of priority from Japanese Patent Application No. 2008-021902, filed Jan. 31, 2008, the entire contents of which are incorporated herein by reference.

### BACKGROUND

1. Field

An embodiment of the invention relates to a recording/reproduction apparatus and a recording/reproduction method, which are designed to record and reproduce video data that changes in content as a user such as a video game player performs an interactive operation.

2. Description of the Related Art

Apparatuses are known, which first record the video data of a video game and later reproduces the video data later. Such an apparatus is disclosed in, for example, Jpn. Pat. Appln. KOKAI Publication No. 2000-197775 (see paragraph 0005). The apparatus disclosed in this publication is of a type on which a football game, for example, can be played. This apparatus can play back the video game backwards and can start the video game again at the scene where the backward playback is stopped. This enables the user to have point-getting scenes that excite the user very much, played back automatically and repeatedly. That is, the apparatus can play back any scene the user likes to enjoy most, again and again, accomplishing a very exciting video game.

The apparatus disclosed in the above patent publication starts playing the game again when the user pushes the start button or when a re-play instruction is automatically made after a “goal” is achieved. When the re-played game comes to an end, the apparatus resumes the game in progress. That is, this apparatus can completely switch the game in progress to a replay game, and vice versa. However, this apparatus is not suitable for playing a video game, such as roll-play game, in which the player usually refers to the past scenes to make the hero (or heroine) get out of a maze.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary diagram showing the overall system configuration of a recording/reproduction apparatus according to an embodiment of this invention;

FIG. 2 is an exemplary block diagram illustrating, in detail, the configuration of the recording/reproduction apparatus shown in FIG. 1;

FIG. 3 is an exemplary flowchart explaining how the recording/reproduction apparatus of FIG. 1 operates;

FIG. 4 is an exemplary diagram explaining how the display mode of the apparatus is switched, between the through-image displaying mode and the through- and recorded-image displaying mode;

FIGS. 5A and 5B are exemplary diagrams depicting the relationship between the display-mode switching and the chapter insertion; and

FIG. 6 is an exemplary flowchart explaining how a screen division instruction is automatically generated.

### DETAILED DESCRIPTION

Various embodiments according to the invention will be described hereinafter with reference to the accompanying drawings. In general, according to one embodiment of the invention, a recording/reproduction apparatus comprises a recording module configured to record input video data; an output module configured to output the input video data to a display apparatus; and a screen division module configured to reproduce, from the recording module, recorded video data related to present video data being outputted to the display apparatus, when a screen division instruction is supplied to the display apparatus while the input video data is being output to the display apparatus, and configured to output synthesized-screen data composed of the video data thus reproduced and the input video data.

An embodiment of a recording/reproduction apparatus according to this invention will be described, with reference to the accompanying drawings.

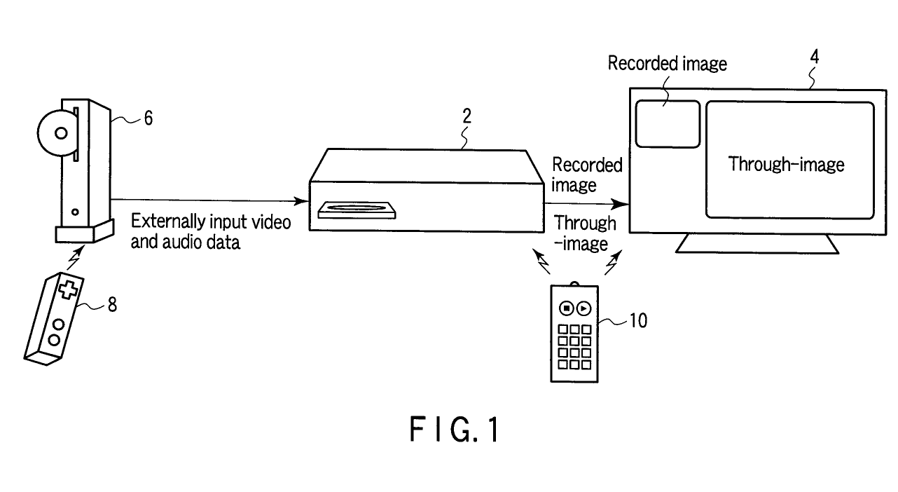

FIG. 1 a diagram showing the overall system configuration of a recording/reproduction apparatus according to an embodiment of the present invention. As FIG. 1 shows, a display apparatus 4 and an external apparatus 6 are connected to the recording/reproduction apparatus 2 that has a storage medium such as a hard disk. The external apparatus 6 is an apparatus that provides video data which changes in content. The apparatus 6 is, for example, a video game apparatus. The video and audio signals supplied from the external apparatus 6 are input to the display apparatus 4 via a high-definition multimedia interface (HDMI) cable. The video and audio signals thus input to the display apparatus 4 are all recorded in the recording/reproduction apparatus 2.

A remote controller 8 is connected to the recording/reproduction apparatus 2 (either by a wire or by radio). Thus connected, the remote controller 8 can output not only game commands, but also various control signals for the recording/reproduction apparatus 2 and display apparatus 4. The control signals are input to the display apparatus 4 through the CEC terminal of the HDMI cable. The control signals include a screen division instruction or a screen division cancellation instruction to be supplied to the display apparatus 4 (sub-screen display on or off). Not two remote controllers, but one remote controller 10 is provided, as in most cases, for both the recording/reproduction apparatus 2 and the display apparatus 4. The recording/reproduction apparatus 2 and the display apparatus 4 may be replaced by, for example, a single television receiver that incorporates a hard disk drive (HDD).

The recording/reproduction apparatus 2 can operate in two data-output modes. In the first data-output mode, the apparatus 2 outputs a first screen to the display apparatus 4. In the second data-output mode, the apparatus 2 outputs a second screen to the display apparatus 4. The first screen (hereinafter referred to as a “through-image”) is represented by the real-time video/audio data supplied from the external apparatus 6. The second screen is a composite screen that consists of a main screen and a sub-screen. The through-image contains audio data, because it is an output of the external apparatus 6. The image displayed in only the sub-screen does not contain audio data at all. In other words, when the display apparatus 4 displays both the main screen and the sub-screen, sound is generated for the main screen, and is not generated for the sub-screen. The data-output mode may be switched manually as the user operates the apparatus 2. Alternatively, the mode can be switched automatically in accordance with a control signal coming from the external apparatus 6 and representing the result of the analysis performed on the real-time video/audio data. The control signal for switching the data-output mode may be supplied first from the remote controller 8 to the external apparatus 6 and then thence to the display apparatus 4 via the HDMI cable. Further, a screen division instruction or a screen division cancellation instruction may be transmitted to the recording/reproduction apparatus 2 from the remote controller 10 to achieve or cancel screen division at the display apparatus 4.

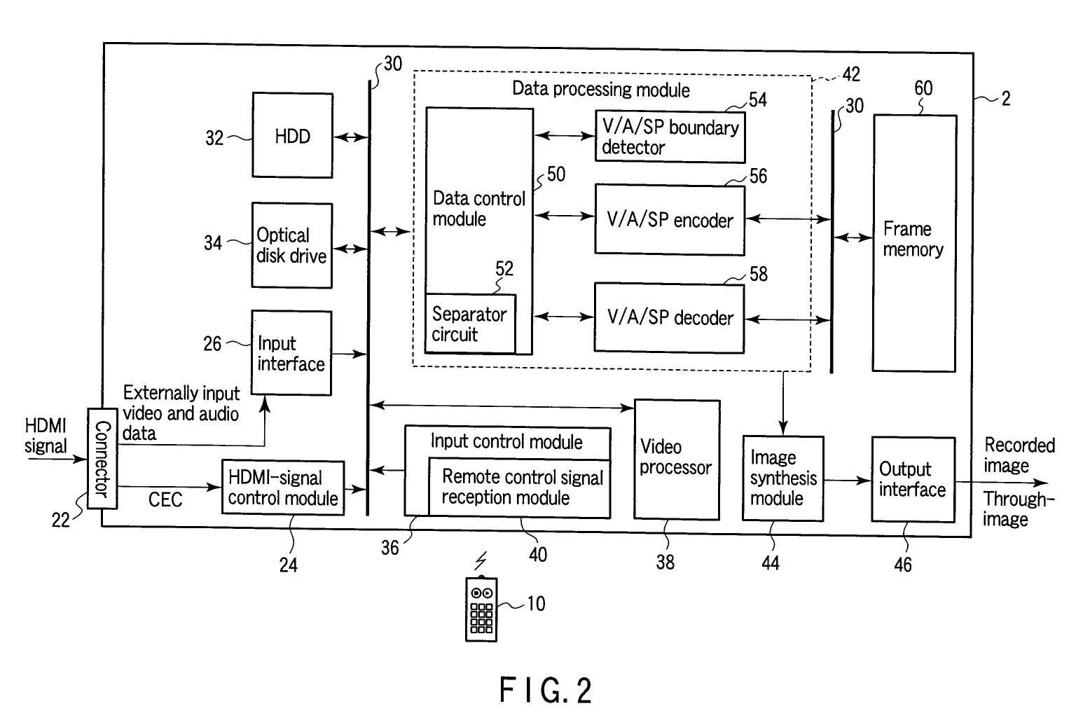

FIG. 2 is a block diagram illustrating, in detail, the configuration of the recording/reproduction apparatus 2.

The recording/reproduction apparatus 2 has a connector 22, which is connected to the HDMI cable of the external apparatus 6. In the recording/reproduction apparatus 2, an externally input video/audio signal is input to an input interface 26, and a screen division instruction or a screen division cancellation instruction is input to an HDMI-signal control circuit 24. The HDMI-signal control circuit 24 and input interface 26 are connected to a system bus 30. To the system bus 30, a hard disk drive (HDD) 32, an optical disk drive 34, an input control module 36, a video processor 38, a data processing module 42, and a frame memory 60 are connected, too. The HDD 32 records the video/audio signal supplied from the external apparatus 6. The optical disk drive 34 can record the video/audio signal, too. A storage medium need not be provided in both the HDD 32 and the optical disk drive 34. Therefore, the optical disk drive 34 can be dispensed with. A flash memory may be used as a storage medium in the apparatus 2. Video/audio signals output from the external apparatus 6 are continually recorded in the recording/reproduction apparatus 2. This is why the apparatus 2 keeps recording data until it receives a recording-stop instruction from the remote controller 10.

The input control module 36 includes a remote control signal reception module 40. Any control signal coming from the remote controller 10 is supplied from the input control module 36 through the system bus 30 to some other circuits provided in the recording/reproduction apparatus 2.

The recording media, such as the disks in the HDD 32 and optical disk drive 34, are provided to record stream data (i.e., MPEG program stream). The data processing module 42 includes a video/audio/sub-picture (V/A/SP) encoder 56. The V/A/SP encoder 56 converts the video/audio signal input from the external apparatus 6 into stream data. The stream data is supplied from the output from the V/A/SP encoder 56 to a data control module 50 that has a buffer memory. In the data control module 50, the stream data is converted to DVD-format data. The DVD-format data is supplied to the video processor 38. The video processor 38 generates record data from the DVD-format data. The video processor 38 can supply the record data to the optical disk drive 34 and can receive the data reproduced from the disk provided in the optical disk drive 34. The video processor 38, which processes data in such modules as data can readily be recorded or reproduced, includes a buffer circuit, a modulation/demodulation circuit, an error correcting module, and the like.

The stream data reproduced from a storage medium, such as the hard disk in the HDD 32 or the disk in the optical disk drive 34, is supplied to the V/A/SP decoder 58 through the separator circuit 52 that is incorporated in the data control module 50. The V/A/SP decoder 58 decodes the stream data, whereby the video signal, audio signal and video/audio/subtitle signal are restored. The data processing module 42 includes a V/A/SP boundary detector 54 that is configured to detect automatically the timing of switching the display mode (to the screen division mode), which will be described later.

The frame memory 60 includes two buffers. One buffer can hold at least one frame of a video/audio signal input from the external apparatus 2. The other buffer can hold at least one frame of a video/audio signal to be output to the display apparatus 4. The rate at which signals are transferred between the buffers and the HDD 32 is much higher than the rate at which signals are written from the external apparatus 6 to the buffers and than the rate at which signals are read from the buffers to the display apparatus 4. Hence, data can be written from the external apparatus 6 to the buffers at the same time data is output from the buffers to the display apparatus 4, even if the data reproduced by the HDD 32 is written to the buffers in time-division fashion. Thus, the data recording and the data reproduction can be achieved in the HDD 32, apparently at the same time.

The signal output from the video processor 38 is supplied to an image synthesis module 44. If necessary, the image synthesis module 44 synthesizes the video/audio signal (i.e., through-image) supplied from the external apparatus 6, with the data representing the main screen, and synthesizes a previous video/audio signal (i.e., recorded image) with the data representing the sub-screen. The synthesized data generated by the image synthesis module 44 is supplied to an output interface 46. On detecting a screen division instruction, the image synthesis module 44 inserts the sub-screen in the main screen, generating a synthesized image. On detecting a screen division cancellation instruction, the image synthesis module 44 closes the sub-screen, generating a screen showing the through-image only. The output of the image synthesis module 44 is supplied via the output interface 46 to the display apparatus 4. The display apparatus 4 displays the image represented by the output of the image synthesis module 44.

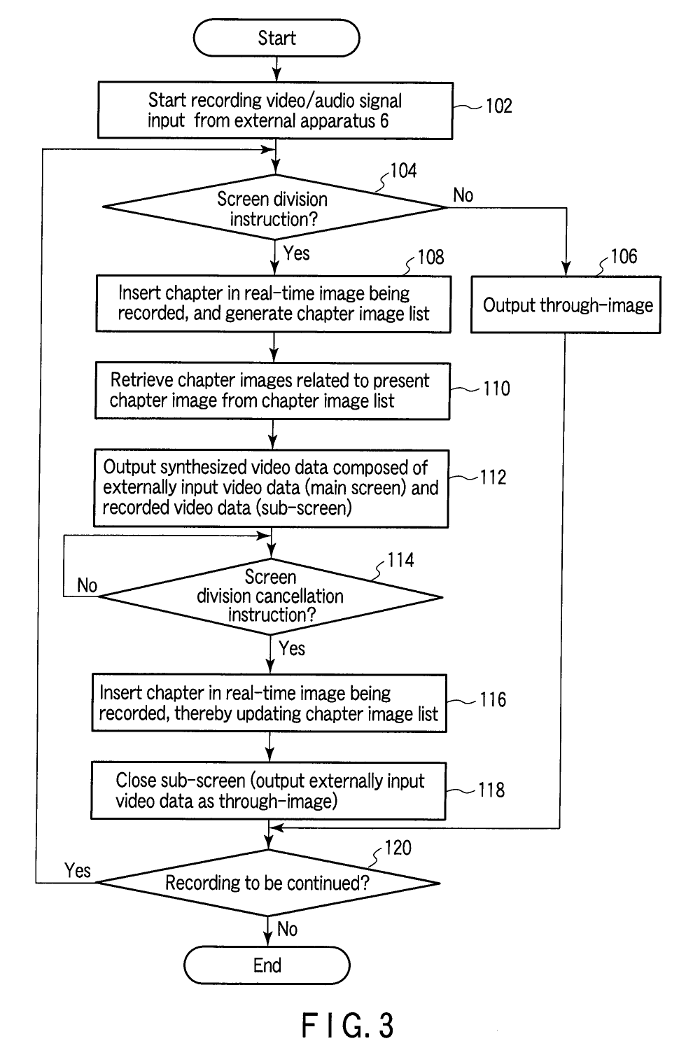

FIG. 3 is a flowchart explaining how the recording/reproduction apparatus 2 operates. Assume that a video game is started at the external apparatus 6 connected to the recording/reproduction apparatus 2 as shown in FIG. 1. Then, the recording/reproduction apparatus 2 starts operating as shown in the flowchart of FIG. 3.

In Block 102, the HDD 32 starts recording a video/audio signal input from the external apparatus 6 and representing a moving picture, or a game screen.

In Block 104, it is determined whether a screen division instruction has been supplied to the recording/reproduction apparatus 2. In most cases, a screen division instruction is supplied from the external apparatus 6, and the real-time video/audio signal recorded in the HDD 32 is output to the display apparatus 4, without being processed at all. If a screen division instruction has been supplied to the apparatus 2, the screen is divided into a main screen and a sub-screen. The real-time video/audio signal is synthesized with the data representing the main screen, and the video data (recorded image) reproduced by the HDD 32 is synthesized with the data representing the sub-screen. As a result, the display apparatus 4 displays a main-screen image and a sub-screen image. The screen division instruction may be input as the user operates the remote controller 8 or 10 as described above. In this case, however, the real-time video/audio signal must be analyzed for its frame characteristic in order to determine whether the screen division should be accomplished or not. The screen division instruction may automatically input if the screen division is desired, as will be explained later in detail.

If no screen division instructions have been supplied to the recording/reproduction apparatus 2, the operation goes to Block 106. In Block 106, the video data supplied from the external apparatus 6 to the recording/reproduction apparatus 2 and recorded in the HDD 32 is output to the display apparatus 4, without being processed at all. (That is, through-image data is output to the display apparatus 4.) Then, in Block 120, it is determined whether the recording should be continued. If the recording should be continued, the operation returns to Block 104. If the recording should not be continued, the operation will be terminated.

In Block 104, a screen division instruction may be found to have been supplied to the recording/reproduction apparatus 2. In this case, the operation goes to Block 108. In Block 108, a chapter is inserted in the real-time image being recorded in the HDD 32, generating or updating a chapter image list. The chapter image list contains the thumbnails of frame images (called “chapter images”), each of which contains chapter data. The chapter image list needs to contain data indispensable in retrieving any past chapter image that is related to the present chapter image. The chapter image list may contain not only the thumbnails, but also the recording-start time, reproduction time, reproduction frequency, subtitle data and audio data of each chapter image.

In Block 110, the chapter image list is retrieved, thereby extracting the past chapter images related to the present chapter image. For example, the past chapter image more similar to the present chapter image than any other in the list is extracted from the chapter image list. Alternatively, the chapter image, which is found most recently recorded or reproduced, based on the recording-start time and reproduction time contained in the chapter image list, may be extracted from the chapter image list. Still alternatively, the chapter image, which is found most frequently reproduced, based on the reproduction frequency contained in the chapter image list, may be extracted from the chapter image list. Further, the chapter image, which has the same subtitle (e.g., “The hero has got into a maze!”) or is accompanied with the same background music (identical scenes are usually accompanied with the BGM), may be extracted from the chapter image list.

Once past chapter images related to the present chapter image have been extracted in Block 110, they can be reproduced from those storage areas of the disk provided in the HDD 32, in which they are recorded. In Block 112, the HDD 32 reproduces data, beginning with these past chapter images, and the image synthesis module 44 synthesizes the through-image with the main screen, and the past images (reproduced images) with the sub-screen. The video data items generated in the image synthesis module 44 are output to the display apparatus 4. The display apparatus 4 can therefore display two images in the main screen and the sub-screen, respectively, one being a real-time image of a scene and the other being an image recorded in the past. Referring to the past image that shows how the hero has passed through the maze, the user playing the roll-play video game can make the hero get out of the maze more easily than before, not getting trapped in the maze many times.

In Block 114, it is determined whether the recording/reproduction apparatus 2 has received a screen division cancellation instruction. If the apparatus 2 has not received a screen division cancellation instruction, the operation returns to Block 114. Thus, the operation will not proceed until the apparatus 2 receives a screen division cancellation instruction. Like the screen division instruction, the screen division cancellation instruction may be input to the apparatus 2 as the user operates the remote controller 8 or the remote controller 10. Alternatively, the screen division instruction may be automatically input to the apparatus 2 if the result of the analysis performed on the real-time video/audio data shows that the screen division should better be performed, and the screen division instruction may be automatically input to the apparatus 2 if the result of the analysis shows that screen division should better be cancelled.

If a screen division cancellation instruction is input, the operation goes to Block 116. In Block 116, a chapter is inserted in the real-time image, whereby the chapter image list is updated.

In Block 118, the sub-screen is closed, whereby the externally input image supplied to the recording/reproduction apparatus 2 from the external apparatus 6 is output to the display apparatus 4, without being processed. (That is, the through-image is output from the apparatus 2.)

Thereafter, it is determined in Block 120 whether the recording should be continued. If the recording should be continued, the operation returns to Block 104. Otherwise, the operation is terminated.

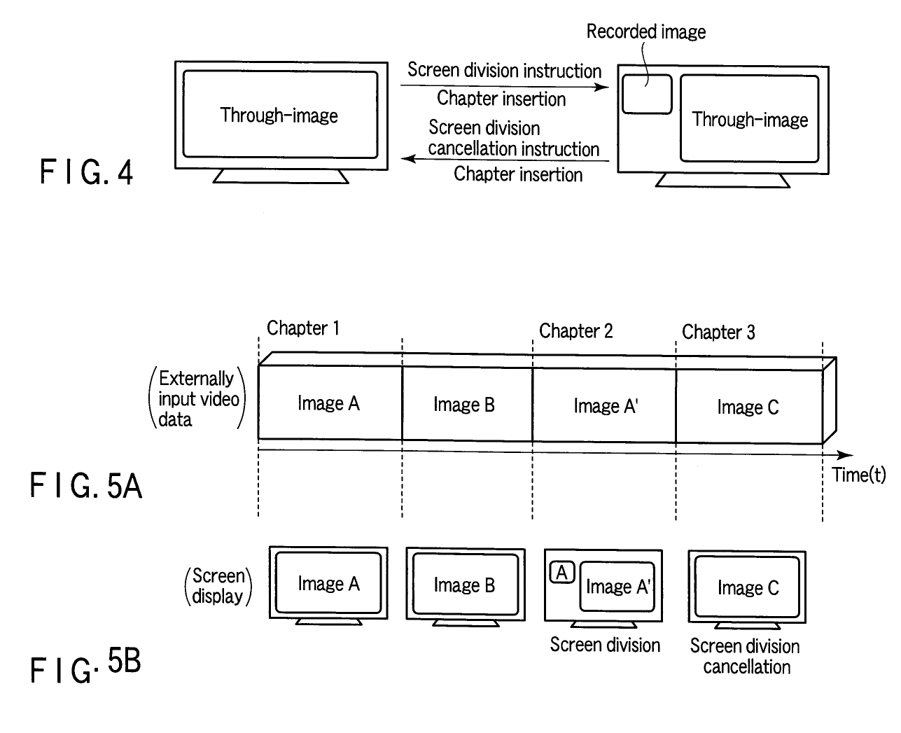

FIG. 4 is a diagram explaining how the display mode of the apparatus 4 is switched. In most cases, the through-image is displayed in the entire screen of the display apparatus 4 as illustrated in the left half of FIG. 4. If a screen division instruction is input to the apparatus 2, the data will be supplied to the display apparatus 4 such that the through-image and the recorded image may be displayed in the main screen and sub-screen, respectively, as illustrated in the right half of FIG. 4. As explained in conjunction with Blocks 108 and 116, a chapter is inserted in the recorded image (i.e., video data supplied from the external apparatus 6), and a chapter image list is generated and updated. The sub-screen or sub-screens can be displayed in any desired number, at any desired positions and in any desired sizes. For example, a plurality of past images may be displayed, together with the through-image at the same time.

FIGS. 5A and 5B are diagrams explaining the process of inserting a chapter in the externally supplied image (i.e., through-image). Chapter 1 is inserted at the head of through-image A (full-screen image). When image B is switched to image A′, a screen division instruction may be input to the apparatus 2. In this case, image A′ (through-image) is displayed in the main screen, whereas image A (recorded image) similar to image A′ is displayed in the sub-screen. Chapter 2 is inserted at the head of through-image A′. When the image is switched from image A′ to a totally different image C, a screen division cancellation instruction is generated. As a result, the sub-screen is thereby closed, and image C is displayed in the main screen. Chapter 3 is then inserted at the tail of through-image A′ (that is, at the head of through-image C). Thus, a chapter is inserted every time the screen is divided. A chapter is registered in the chapter image list at the time the screen is divided. This is because the scene labeled with any chapter registered will, in the future, possibly be displayed in the sub-screen and referred to.

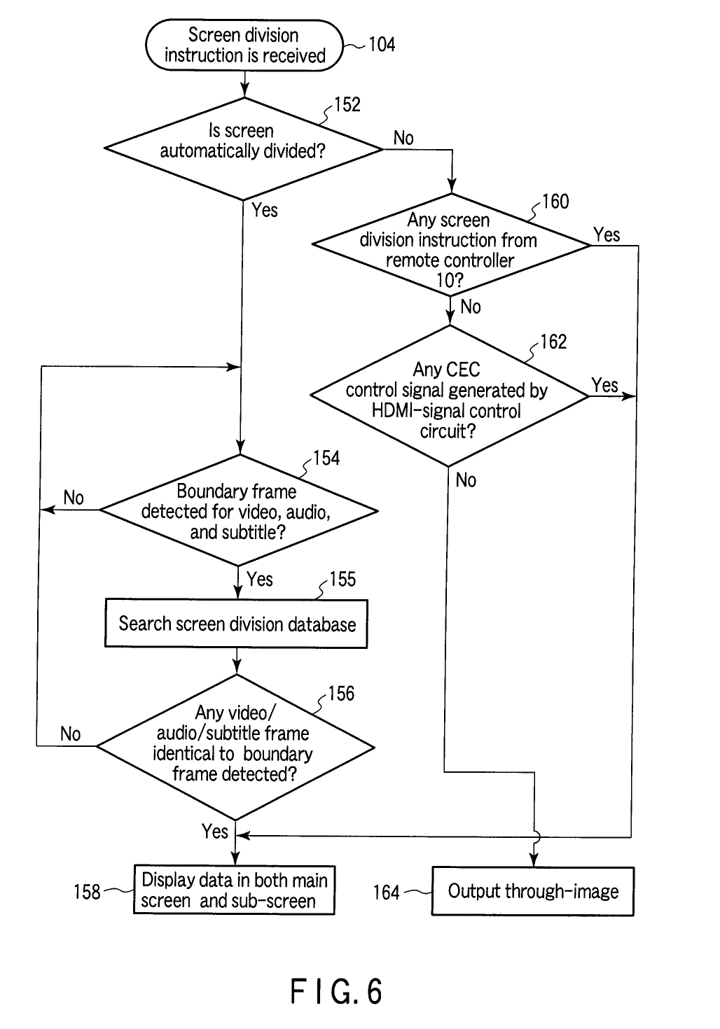

FIG. 6 is a flowchart explaining how a screen division instruction is generated (in Block 104 shown in FIG. 3).

Assume that the user can set the recording/reproduction apparatus 2 so that the screen division instruction may be generated automatically. Even if the apparatus 2 is so set, the user may operate the remote controller 8 or 10 to generate a screen division instruction.

In Block 152, it is determined whether the recording/reproduction apparatus 2 has been set to generate a screen division instruction automatically. If the apparatus 2 is set to generate a screen division instruction automatically, the operation goes to Block 154. In Block 154, the V/A/SP boundary detector 54 detects a boundary frame where the externally input image changes in content, sound and subtitle. If the image changes in content, the V/A/SP boundary detector 54 detects the boundary frames between image A, image B, image A′ and image C, or any frame in which the sound or subtitle greatly changes. In the case of a video game, the image greatly changes in BGM or content, or the subtitle of “The hero has got into a maze!” appears in the image.

In Block 155, a database is searched in order to generate a screen division instruction automatically. More precisely, the database is searched for a video-audio-subtitle frame identical to those of any boundary frame detected. Note that the database has been prepared by compiling the video data items, audio data items and subtitle data items of those of the images displayed in the past, which are useful to the user to proceed with the game successfully. If all externally input images are compared with the database, the load of process will be tremendous. Therefore, only the boundary frames are extracted and compared with the database. This can reduce the load of process.

In Block 156, it is determined whether the database has a video-audio-subtitle frame that is identical to any boundary frame detected in Block 155. The criterion for this decision can be the resolution of the image, the rectangular region selected for the image, the luminance or color of the image, and number of frames compared. If the database is found to have no video-audio-subtitle frames identical to any boundary frame detected, the operation returns to Block 154. If the database is found to have a video-audio-subtitle frame identical to any boundary frame detected, the operation goes to Block 158, in which data is displayed in both the main screen and the sub-screen, as explained with reference to Blocks 108 to 120 shown in FIG. 3.

In Block 152, the recording/reproduction apparatus 2 may be found not set to generate a screen division instruction automatically. If this is the case, the operation goes to Block 160. In Block 160, it is determined whether a screen division instruction has come from the remote controller 10. If a screen division instruction has come from the remote controller 10, the operation jumps to Block 158, in which the data is displayed in both the main screen and the sub-screen. If no screen division instructions have come from the remote controller 10, the process goes to Block 162. In Block 162, it is determined whether a screen division instruction (CEC control signal generated by the HDMI-signal control circuit 24) has come from the remote controller 8. If a screen division instruction has come from the remote controller 8, the operation goes to Block 158, in which the data is displayed in both the main screen and the sub-screen. If no screen division instructions have come from the remote controller 8, the operation goes to Block 164, in which the through-image is output, as explained with reference to Block 106 shown in FIG. 3.

According to the first embodiment of this invention, the display apparatus 4 always holds the video and audio data output from the external apparatus 6 (e.g., a video game apparatus). Also, the video and audio data is output as through-image to the display apparatus 4. A video signal can be output to the display apparatus 4 in two modes. The signal output in one output mode includes through-image only. The signal output in the other output mode includes through-image data to be displayed in the main screen and a past image (reproduced image) related to the present through-image and to be displayed in the sub-screen. Either output mode can be automatically selected. Thus, a real-time image of a scene and a past image of the same scene can be displayed in the main screen and the sub-screen, respectively. The user can therefore proceed with the game, referring to the information acquired in the past. This helps the user to train himself or herself efficiently to become an excellent player of the game. Further, the screen division for displaying an image in the sub-screen, and the retrieval of the past image to display in the sub-screen can be automatically performed in accordance with the characteristic of the present image. The user need not operate the apparatus 2 to divide the screen or to retrieve the past image, and can therefore concentrate his mind on the video game.

As described above, the apparatus and method according to the present embodiment can display the present scene and any past scene related to the present one at the same time. Therefore, the user can perform an interactive operation, while referring to the past scene. If used to play a video game, the apparatus and method can help the user to become an excellent player of the game. The present embodiment can provide a recording/reproduction apparatus and a recording/reproduction method, which can display an image that changes in content as the user performs an interactive operation and which can display a past scene related to the present scene, along with the present scene.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions. For example, the reproduced image displayed in the sub-screen is purely visual data in the embodiment described above. The image may be accompanied with sound, nevertheless. In this case, the sound to output may be switched to one that accompanies the image displayed in the main screen or to one that accompanies the image displayed in the sub-screen. Moreover, a plurality of sub-screens may be displayed, though only one sub-screen is displayed in the embodiment described above. Further, the sub-screen may be displayed for only a preset time after the receipt of a screen division instruction, though the screen division is nullified when a screen division cancellation instruction is input either automatically or manually in the embodiment described above.

What is claimed is:

1. A recording/reproduction apparatus comprising:
a recording module configured to record input video data;
an output module configured to output the input video data to a display apparatus; and
a screen division module configured to reproduce, from the recording module, recorded video data related to present video data being outputted to the display apparatus, when a screen division instruction is supplied to the display apparatus while the input video data is being output to the display apparatus, and configured to output synthesized-screen data composed of the video data reproduced and the input video data.

2. The recording/reproduction apparatus of claim 1, further comprising:
a detecting module configured to detect a changing frame in the input video data;
a determining module configured to compare the changing frame detected by the detecting module, with a prescribed database, thereby to determine whether the changing frame is a specific frame; and
an instruction generating module configured to generate the screen division instruction when the determining module determines that the changing frame is the specific frame.

3. The recording/reproduction apparatus of claim 2, wherein the detecting module detects a frame that has changed by a value greater than a threshold in at least one of video, audio and subtitle data items constituting the input video data; and the determining module uses a given database comprising a plurality of frames at which to generate a screen division instruction, thereby to determine which frame is identical to the changing frame.

4. The recording/reproduction apparatus of claim 1, further comprising:
a chapter inserting module configured to insert a chapter in the input video data recorded by the recording module, every time synthesized-screen data is generated in response to the screen division instruction; and
a chapter image list generating module configured to generate a chapter image list including chapter images that are video data items, each input at timing of inserting a chapter, wherein
the screen division module finds a chapter image most similar to a latest chapter image, in the chapter image list, and reproduces data representing the chapter image from the recording module.

5. The recording/reproduction apparatus of claim 4, wherein
the chapter image list further includes recording-start time, reproduction frequency and latest reproduction time about each chapter image; and
the screen division module finds a chapter image of the latest recording-start time, a chapter image of the highest reproduction frequency or a chapter image of the latest reproduction time, and reproduces the recording data about the chapter image found.

6. The recording/reproduction apparatus of claim 1, wherein the screen division module reproduces recorded video data items related to the present video data, from the recording module, and outputs synthesized-screen data formed of the recorded video data items and the input video data.

7. The recording/reproduction apparatus of claim 1, further comprising a user operation member configured to generate the screen division instruction at a given timing.

8. The recording/reproduction apparatus of claim 1, wherein the recording/reproduction apparatus incorporates the display apparatus.

9. The recording/reproduction apparatus of claim 1, further comprising a screen division cancellation module configured to interrupt a reproduction of the video data when a screen division cancellation instruction is generated while the screen division module is outputting the synthesized-screen data, and configured to output the input video data to the display apparatus.

10. A recording/reproduction method comprising:
recording input video data and outputting the input video data to a display apparatus; and
reproducing recorded video data related to present video data being outputted to the display apparatus, when a screen division instruction is supplied to the display apparatus while the input video data is being output to the display apparatus, and outputting, to the display apparatus, synthesized-screen data formed of the video data reproduced and the input video data.

11. The recording/reproduction method of claim 10, further comprising:
detecting a changing frame in the input video data;
comparing the detected changing frame, with a given database, thereby to determine whether the changing frame is a specific frame; and
generating the screen division instruction when it is determined that the changing frame is the specific frame.

12. The recording/reproduction method of claim 10, further comprising:
inserting a chapter in the input video data recorded every time synthesized-screen data is generated in response to the screen division instruction; and
generating a chapter image list formed of chapter images that are video data items, each input at timing of inserting a chapter, wherein
a chapter image most similar to a latest chapter image is found in the chapter image list, and data representing the chapter image is reproduced.

13. The recording/reproduction method of claim 10, wherein recorded video data items related to the present video data are reproduced and, and synthesized-screen data formed of the recorded video data items and the input video data is output to the display apparatus.

14. The recording/reproduction method of claim 10, further comprising interrupting a reproduction of the video data when a screen division cancellation instruction is generated while the synthesized-screen data is being output to the display apparatus, and outputting the input video data to the display apparatus.
